(19) United States
(12) Patent Application Publication
(10) Pub. No.: US 2003/0167224 A1
(43) Pub. Date: Sep. 4, 2003

(54) Sequential execution system of trading orders

(76) Inventor: Vijay K. Periwal, Sunnyvale, CA (US)

Correspondence Address: Donald W. Meeker, Patent Agent, 924 East Ocean Front, #E, Newport Beach, CA, 92661, US

(21) Appl. No.: 10/339,608

(22) Filed: Jan. 9, 2003

Related U.S. Application Data
(60) Provisional application No. 60/358,837, filed on Feb. 22, 2002.

(51) Int. Cl. G06F 17/60

(52) U.S. Cl. 705/37

(57) ABSTRACT

A programmable trading system for explicitly and or automatically inputting a number of trading orders, such as offers to buy and sell shares of stocks or other types of offers, such that some or all of the trading orders are executed in a particular sequence based on specified criteria and provide the ability to investors to place multiple trading orders from a single order input which provides transaction pattern information of the trading orders. While each programmed transaction is being completed the other transactions are temporarily blocked until another of the orders in the sequence can be transacted based on the given programmed criteria. The system may comprise multiple layers of trading sequences including a number of programmable groups, each of the groups having a number of transactions.

### CLAIM OF PROVISIONAL APPLICATION RIGHTS

This application claims the benefit of U.S. Provisional Patent Application No. 60/358,837, filed on Feb. 22, 2002.

### BACKGROUND OF THE INVENTION

1. Field of the Invention

The present invention relates to programmed systems for buying and selling and in particular to a system for explicitly and or automatically inputting a number of trading orders, such as offers to buy and sell shares of stocks or other types of offers, such that some or all of the trading orders are executed in a particular sequence based on specified criteria and provide the ability to investors to place multiple trading orders from a single order input based on a given pattern information.

2. Description of the Prior Art

Buying and selling stocks or commodities or participating in any type of trading by investors can be an arduous task requiring constant vigilance, and great fortune in being able to contact a broker to buy or sell at just the right moment, or great frustration and loss in not being able to contact a broker at the right time.

Often an investor has a limited amount of money to invest, but would like the option of being able to buy and sell in a series of trades to make some profit by buying a certain stock at a set low price and selling it when it reaches a set higher price. It may then be desirable to buy the same stock again if it reaches the set low price or to buy other stocks if they reach a set low price, but always being able to sell first to insure that there is sufficient money to make the subsequent stock purchases.

An investor might have a number of stocks to consider buying if they reach a set low price, but only have sufficient funds available to make one of the purchases at a time and then have to wait to sell the purchased stock before buying any of the others or the same stock again if it reaches the set low price.

Using prior systems there is no option for investors to place orders for multiple trades, which will guarantee the ordering of trades. In fact with the current buy and sell trading options, many times investors end up buying or selling a security, which s/he intended to do only if some other trade (buy/sell) happened.

For Example:

One investor with $6000.00 in his/her account would like to make the following trades in the given sequence one after another:

| Security | Buy/Sell | Quantity | Price | Total |
|---|---|---|---|---|
| 1: Microsoft | Buy | 100 | $60.00 (Limit order) | $6000 |
| 2: Microsoft | Sell | 100 | $62.00 (Limit order) | $6200 |
| 3: IBM | Buy | 50 | $110.00 (Limit order) | $5500 |
| 4: IBM | Sell | 50 | $120.00 (Limit order) | $6000 |
| 5: Home Depot | Buy | 100 | Market order ($50.00) | $5000 |

With the current available trading options, there is no way that an investor can place the order(s) to be executed in the desired sequence without constantly watching the market. In fact one has to place the orders one by one as they complete, which is almost impossible for average investors, who are not involved full time in the stock market, as their primary jobs are something else and they just want to make some money from their savings by investing in the stock market.

If an investor doesn't want to watch the market constantly and place orders one after another as they complete, with the current trading system, s/he may place all the orders simultaneously but then s/he may end up with multiple permutations and combinations of the above securities purchase or sell orders. For example, out of the above 5 orders, the following three trade may execute: 1, 3, and 5 (buy 100 shares of Microsoft at $60.00 per share, buy 50 shares of IBM at $110.00 per share, and buy the 100 Home Depot shares at market price, which is $50.00) without executing the order number 2 and 4 (sell of 100 Microsoft shares at $62 per share and sell of 50 IBM shares at $120 per share). Following is the tabular format of the executed orders:

| Security | Buy/Sell | Quantity | Price | Total |
|---|---|---|---|---|
| 1: Microsoft | Buy | 100 | $60.00 (Limit order) | $6000 |
| 3: IBM | Buy | 50 | $110.00 (Limit order) | $5500 |
| 5: Home Depot | Buy | 100 | Market order ($50.00) | $5000 |

If we take a closer look at the above transactions we will find that this investor bought 3 different securities without selling either Microsoft or IBM securities and the total investment amount is $16500.00 which s/he never planned to invest as s/he had only $6000.00 in his/her account.

In another scenario, without Sequence Trading, the investor may end up selling a security without buying it. For example, assuming the current price of Microsoft stock is $61.00 and an investor intended to buy 100 shares at $60.00 per share and sell at $62.00 per share, but the stock price rises to $62.00 without going down to $60.00, the investor may end up trying to sell the security without even owning it. Following is the tabular format of above transaction.

| Security | Buy/Sell | Quantity | Price | Total |
|---|---|---|---|---|
| 2: Microsoft | Sell | 100 | $62.00 (Limit order) | $6200 |

To avoid the above situation, in current buy and sell security systems, one has to wait until the execution of the first order before placing the next order.

While there have been attempts to create automated trading systems they all lack an ability to automatically sequence trading with a first transaction, such as a buy based on one out of a number of options meeting a specified low market price limit being reached and spending only a set amount of money, taking place automatically when conditions are met and automatically blocking the other transactions until a second desired option out of a number of options is possible, such as selling at a specified market high an owned stock or commodity or other item and then automatically causing the second option to take place while automatically blocking the other transactions until a third desirable option opens up, all the while limiting the transactions to the desired preprogrammed sequence of trades which works within a set amount of money, only buying what is possible with the set amount of money and always waiting to buy until other items are sold to insure the set amount of money is available to buy.

U.S. patent application 20020073014, by Gilbert, is for systems and methods for shifting bids and/or offers in a trading interface. Using these systems and methods, a trader may access various bid and/or offer data, adjust bid and/or offer statuses, and shift a plurality of bid and/or offer prices and sizes to accommodate for changes in a trading environment. The trading interface may provide users with multiple bid and/or offer interaction. This may allow users to apply changes to a plurality of bids and/or offers simultaneously and provide time efficient bid and/or offer shifting. The bids may be made active or inactive and may be made to happen automatically.

U.S. Pat. No. 6,418,419, issued Jul. 9, 2002 to Nieboer, provides an apparatus and method of automatically and anonymously buying and selling positions in fungible properties between subscribers. The specific embodiment described in the disclosure relates to the buying and selling of securities or contracts where the offer to purchase or sell the property may be conditioned upon factors such as the ability to purchase or sell other property or the actual purchase or sale of other property. Specifically, the system described includes methods by which the system will sort and display the information available on each order, methods by which the system will match buy and sell order and attempt to use other markets to effect the execution of transactions without violating conditions set by the subscriber, methods by which the apparatus will execute transaction and report prices to third parties such that the user is satisfied and short sales are reported as prescribed by the rules and regulations of the appropriate regulatory body governing each subscriber in the associated transaction. A communication system is described which allows subscribers to communicate anonymously for the purpose of effecting transactions in such property under such conditions.

U.S. Pat. No. 6,317,728, issued Nov. 13, 2001 to Kane, describes a securities trading system based on the principles of artificial intelligence. It includes a data acquisition system having an input communicating with a securities exchange for receiving securities buy/sell data; a clock for generating clock times; a processing logic having inputs respectively communicating with the data acquisition system and with the clock for assigning respective clock times to said buy/sell data; a decision logic having a repository for storing a set of buy/sell rules for buying and selling securities in response to the buy and sell data aligned with the clock times; and a buy and sell execution system having an input communicating with the decision logic for executing buy and sell orders in conformance with the buy/sell rules. In the securities trading system according to the invention, the decision logic includes at least one decision agent, the agent representing a respective buy/sell rule, wherein further the decision logic may include at least two decision agents, each decision agent representing a respective buy rule or a respective sell rule. Artificial intelligence is provided in that the decision agents are rewarded in a feedback arrangement by being given added or reduced voting power when their recommendations are found to respectively result in successful or unsuccessful decisions. Thereby a self-learning feature is provided which results in improving the performance of the system as the number of transactions increase.

U.S. Pat. No. 6,317,726, issued Nov. 13, 2001 to O'Shaughnessy, discloses using a computer to select corporate stocks for investment. Fifty stocks are selected from a database on the basis of certain criteria. The stocks are acquired in equal proportions, and the portfolio is rebalanced at the end of an annual term. Strategy I: market capitalization greater than $172 million (inflation adjusted figure for $150 million in 1994 dollars.); price-to-sales ratio less than 1.5; earnings higher than in previous year; market capitalization greater than market capitalization three months ago; market capitalization greater than market capitalization six months ago; buy stocks with highest one-year stock price appreciation. Strategy II: market capitalization greater than database mean; common shares outstanding greater than database mean; cashflow greater than the database mean. (creating SET A); price-to-sales ratio less than average for SET A; sales greater than 1.5 times the average for the database; no utility companies; buy the 25 or 50 stocks with the best one year stock price appreciation.

U.S. Pat. No. 6,311,178, issued Oct. 30, 2001 to Bi, relates to a computer matching system used by a plurality of users and the method therefor, said system comprising a database; an offer creation program means for creating an entity for an offer input by each user in the database and storing said offer therein; and a search engine for comparing and matching a requirement input by a user with other users' offers stored in the database and returning matching results to said user. Advantageously, said requirement includes multiple elements as search criteria, each of said elements is assigned a weight of importance thereby each matching result has a search score indicating satisfaction level of said user, said search engine further perform ordering and ranking of said matching results according to the respective search scores thereof, and only the matching results have search scores above a predetermined satisfaction level are returned to said user. Said multi-element confidence matching system can automatically provide the user or trader with the information he is interested in without the intervention of the trader, and give the user the maximum amount of information about offers which may meet their requirement, so as to give the trader the ability to not just see offers which exactly match their criteria, but ones which come close or can fulfill part of, or more than, their needs, thereby the trader may conduct the search efficiently.

U.S. Pat. No. 6,134,535, issued Oct. 17, 2000 to Belzberg, puts forth an improvement in computer automated stock exchange trading whereby a graphic user interface with a mouse and display is used to select parameters such as share symbol, price selection, order size, and transaction type, as well as other indicators to launch a trading order to the order entry system of a stock exchange computer. Further improvements include a programmed interface by which data on a group of shares may be read from a spreadsheet formulated into an order and launched automatically or in response to a signal from an operator so as to trade an index or basket of shares substantially instantaneously.

U.S. Pat. No. 6,292,787, issued Sep. 18, 2001 to Scott, concerns a portfolio optimization process that diversifies model risk by favoring a more diversified portfolio over other portfolios with similar characteristics. According to one aspect of the present invention, a more diverse portfolio may be selected over an initial portfolio in order to diversify model risk with reference to a predetermined diversity budget, defined in terms of expected return, risk, and/or utility. An initial portfolio of financial products is determined from an available set of financial products. One or more dimensions of an error space are searched for an alternate portfolio that is more diverse than the initial portfolio. A cost associated with the alternate portfolio is then calculated by comparing the difference between a characteristic of the initial portfolio and a corresponding characteristic of the alternate portfolio. Finally, the alternate portfolio is selected as the recommended portfolio if the cost is less than or equal to the predetermined diversity budget. According to another aspect of the present invention an intelligent search is performed for a diverse portfolio that meets a predetermined diversity budget. An initial portfolio is determined based upon an available set of financial products. The cost associated with more diversified portfolios compared to the initial portfolio is considered and one of the more diversified portfolios is selected that has an associated cost that is less than or equal to the predetermined diversity budget.

U.S. Pat. No. 5,305,200, issued Apr. 19, 1994 to Hartheimer, illustrates a distributed processing on-line automated trading system using structured messages to represent each stage in the negotiation between a market maker (quoter) and a potential buyer or seller (requester). Such a system is subject to uncertainties caused by the fact that a variable time is required for an order (buy or sell) message to be transmitted from the requestor to the quoter, or for a cancel (quote interrupt) message to be transmitted from the quoter to the requester. Furthermore, it is possible that an equipment failure in the network, either in a communication link or even at the workstation of one of the traders, will prevent a small fraction of such order messages and cancel messages from reaching their intended destination within the relatively short time-frame typically associated with an on-line transaction system. An electronic log maintained by the quoter's workstation provides a reliable and impartial mechanism for automatically verifying whether an order was actually received by the quoter, and for thereby resolving whether the quoter is committed to accept an order that was placed during the small (typically only a few seconds) window of uncertainty after an order is placed and before the requester would have been notified that the order was accepted or the quote was interrupted or a failure had occurred in the relevant communication link. In addition, the system regularly reviews a second transaction log maintained by the requestor's workstation for any “doubtful” transactions (i.e., those designated as “order in process” for more than a few minutes), including “doubtful” transactions which were not resolved when any network failure message was originally received, and those which were the result of a failure associated with the requestor's workstation.

U.S. patent application No. 2002/0035,606 by Kenton is for a method and system for performing straight through processing. The method includes monitoring a queue in order to detect a specific message. This message is parsed to take it from an external format into an internal format. The contents of the message include stages, with one stage being marked as active, and each stage having at least one step and a queue identifier. The processing specified in the steps contained in the active stage is performed, the active stage is marked inactive, and a new stage is marked active. The message is parsed back into the external format and directed to the queue specified by the queue identifier. Additional embodiments include a storage medium and a signal propagated over a propagation medium for performing computer messaging.

U.S. patent application No. 2002/0038,282 by Montgomery is a system, method, and computer program product for automating an interaction between a buyer and an electronic, variable, dynamic pricing online auction service. The method can include receiving a registration of a buyer at an Internet enabled buyer bidding site, a portfolio, and account information. The method can also receive entered information about financial transaction instruments, contact information, and product preferences in an auction profile. The method can receive a search query for a desired product from product auctions of a plurality of auction sites and can use a search agent or a meta-search agent, and can provide returned auctions, including retrieving and presenting current status of product auctions. The method can receive a selection of returned auctions to store in the portfolio for tracking by scan agents and for bidding by bid proxies. The method can receive selections of product auctions of the returned auctions and place the product auctions into the portfolio for use by a cascaded bid proxy. The method can provide auction monitoring by scan agents of temporal progression of product auctions, and can notify someone via a messaging center of any changes in relevant aspects of the status that could prevent an initial bid from being placed by a bid proxy. The method can enable activation of bid proxies as an auction nears completion to begin placing bids until the auction is won or lost by auction closing and can confirm a counter-offer has not out-bid. The method can compute and execute another higher bid if a counter-offer has been made and accepted, higher than the most recent bid detected.

U.S. Pat. No. 3,573,747, issued Apr. 6, 1971 to Adams, is for an apparatus and method of automatically, anonymously and equitably buying and selling fungible properties between subscribers. Described is a communication system which permits institutional investors to communicate anonymously with each other to arrange block trades of listed and over-the-counter securities. The method of the system comprises the steps of (1) booking unfilled buy offers including associated price and quantity parameters on a buy offer list in a priority sequence according to a first predetermined program, (2) booking unfilled sell offers including associated price and quantity parameters on a sell offer list in a priority sequence according to a second predetermined program, (3) comparing in priority sequence, the price and quantity parameters of each incoming offer with the corresponding parameters of each offer on the complementary list, (4) transacting the received offer with the higher priority offers on the complementary list if the incoming offer can be matched against one or more offers on the complementary offer list, and (5) placing the untransacted portion of the received offer on the corresponding list in a priority sequence according to the corresponding predetermined program if the incoming offer cannot be completely matched against offers on the complementary offer list.

What is needed is a system for explicitly and or automatically inputting a number of trading orders, such as offers to buy and sell shares of stocks or other types of offers, such that some or all of the trading orders are executed in a particular sequence based on specified criteria and provide the ability to investors to place multiple trading orders from a single order input based on a given pattern information. None of the prior art systems provide this option.

### SUMMARY OF THE INVENTION

A primary object of the present invention is to provide a trading system for explicitly and or automatically inputting a number of trading orders, such as offers to buy and sell shares of stocks or other types of offers, such that all or some of the trading orders are executed in a particular sequence based on specified criteria and provide the ability to investors to place multiple trading orders from a single order input based on a given pattern information.

A further object of the present invention is to provide multiple layers of trading sequences comprising a number of programmable groups, each of the groups having a number of transactions, wherein the system is capable of automatically programming each of the groups independently of each of the other groups.

A further object of the present invention is to provide a system to place multiple trading orders from one order input based on a given pattern information. This will save significant time for the investors as they don't have to enter a similar order again and again.

An object of the present invention is to help investors, such as stock market investors, to reduce their risk without worrying about the change in the market every minute by maintaining a real time awareness of the actual amount of money available and ordering the sequence accordingly to make real buys based on money available and real sales based on items actually owned.

Another object of the present invention is to help the brokerage firms so that they will have to worry less about the margin call to their investors as investors can reduce the risk and manage the purchase and sale of the securities automatically and with the assurance that the investors are not spending more money than they actually have.

One more object of the present invention is to provide the investor with a system which will make sure that the investor will not go beyond set limits in terms of buying and selling the securities, commodities or other traded items.

In brief, the present invention will provide the investors with the ability to place multiple buy or sell orders of the securities in the order they want to execute so that the next order will be executed only if the previous one is completed. It also provides multiple sequence paths where it will cancel all the orders of other (unselected) paths at the same level once it selects a sequence path. It also provides the investors the ability to place multiple trading orders from a single order input based on a given pattern information.

The present system provides an ability for automatic sequence trading with a first transaction, such as a buy based on one out of a number of options meeting a specified low market price limit and spending only a set amount of money, taking place automatically when conditions are met and automatically blocking the other transactions until a second desired option out of a number of options is possible, such as a sell at a specified market high selling an owned stock or commodity or other item, and then automatically causing the second option to take place while automatically blocking the other transactions until a third desirable option opens up, all the while limiting the transactions to the desired preprogrammed sequence of trades which works within a set amount of money only buying what is possible with the set amount of money and always waiting to buy until other items are sold to insure the set amount of money is available to buy.

Sequence trading of a security can be done for the same security, for example, IBM, IBM, IBM, or multiple securities, for example, IBM, Microsoft, Intel, etc., or in the mix format where there can be one security more than one time along with other securities, for example, IBM, Microsoft, IBM, Intel, etc.

Purchase or sell orders can be used with the same criteria which is currently used, for example, buy or sell the security at a particular price known as limit order, buy or sell the security at the market price, or buy or sell the security with in a time limit, short sell, etc.

With the Sequence Trading one is assured that the next order will only be executed until the previous order is fulfilled. In another words, in FIG. 2, the 100 shares of Microsoft won't be sold at price $62.00 until it is bought at price $60.00 and the 50 IBM stock won't be bought at price $110.00 until the Microsoft stock is sold, and so on.

This new way (Sequence Trading) of security trading of the present invention will give full control of trading to the individual investors as well as peace of mind as they will be fully assured that they won't run into a situation where they buy more securities than they intend to, or where they sell a security without owning it.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a diagrammatic view of the sequence trading system of the present invention showing that while there are multiple orders open at the same time, they will be executed only in the order they are placed, for example, the “Sell 100 MSFT $62.00 Limit Order” will not be executed until the “Buy 100 MSFT $60.00 Limit Order” is executed;

FIG. 2 is a diagrammatic view of the sequence trading system of the present invention showing that there can be multiple securities as part of the sequence order, for example MSFT (Microsoft) and IBM, as compared to the single security in FIG. 1;

FIG. 3 is a diagrammatic view of the sequence trading system of the present invention showing that there can be multiple choices as part of the sequence trading, in which one sequence will be followed, thereby canceling the other sequence;

FIG. 4 is a diagrammatic view of the sequence trading system of the present invention showing in more detail the possible sequence paths for the scenario of FIG. 3;

FIG. 5 is a diagrammatic view of the sequence trading system of the present invention showing that the multiple choices can occur at any point in the sequence, in this example, from the very first transaction, in contrast to the scenario in FIG. 3, where the multiple choice occurs in the middle of the sequence;

FIG. 6 is a diagrammatic view of the sequence trading system of the present invention showing more detail of the multiple choice sequence possibilities for the scenario of FIG. 5;

FIG. 7 is a diagrammatic view of the sequence trading system of the present invention showing that different types of orders can be placed as part of sequence trading e.g. limit order, market order, limit order based on price of earlier trade;

FIG. 8 is a diagrammatic view of the sequence trading system of the present invention showing that from one trading order input, the system can generate multiple buy and sell orders for a particular stock, in this example, Intel;

FIG. 9 is a diagrammatic view of the sequence trading system of the present invention showing the same scenario as FIG. 8, but specifying “Profit Percent” for the selling price, which computes the selling price, in this example $33.00 ($30.00+10%), and that the order will be valid until a specific date, in this example Jan. 1, 2003, instead of a number of days;

FIG. 10 is a diagrammatic view of the sequence trading system of the present invention showing an order to sell a particular stock, in this example, MSFT (Microsoft), at market price, and that the buy price will be determined by the first sell price, in this example, 5% below the sell price, and that the order will be valid for one day only, illustrating also that the number of buy orders can be different from the number of sell orders;

FIG. 11 is a diagrammatic view of the sequence trading system of the present invention showing a single input order to buy a particular stock, in this example, MSFT (Microsoft), at $60.00, and then sell the same stock with a $2.00 profit, in this example $62.00 ($60.00+$2.00=$62.00), and then buy the same stock at $1.00 below the last sale price, in this example $61.00 ($62.00−$1.00=$61.00), the process continuing in sequence until all trades are completed, thereby allowing the user to make the trades even if the stock price rises and does not return to the last buy price;

FIG. 12 is a diagrammatic view of the sequence trading system of the present invention showing the average out capability, in this example, an order to buy 1000 stock of Intel (INTC) every time price of this stock goes down by 10% so that investor can average out his buying price even if the stock price continues to go down. In this example the total number of buy orders are 3 and the first order will be executed when price of the Intel stock will be at $30.00 and the order is valid till Jan. 1, 2003. One can also choose to sell the stock in a similar fashion when the market goes up.

FIG. 13 is a diagrammatic view of the sequence trading system of the present invention showing the sell short order, in this example, the investor would like to sell short the IBM stock every time it goes up by 10%. The first trade will take place once the stock will reach a price of $100.00, next at the price of $110.00 ($100+10%), and last at the price of $121.00 ($110+10%).

### BEST MODE FOR CARRYING OUT THE INVENTION

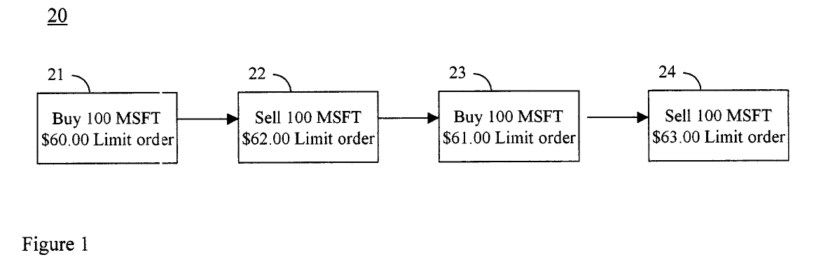

FIGS. 1-13 provide diagrammatic examples of the functioning of the present system for automatically programmed sequential trading capability, transaction exclusion capability, placing multiple trading order capability from a single input, and a real time accountability of actual funds and tradable items available, the system operable in any programmable or interactive programmable equipment including in real time or interactive real time programmable equipment. The system comprises automatically programming a number of transactions to take place in a desired sequence, the sequence being to have a first transaction of the number of transactions to meet a given order criteria take place automatically and simultaneously canceling (excluding) the transactions of unselected paths at the same level which won't be considered for the trading any more; and on completion of first transaction automatically executing the next transaction based on the given order criteria and simultaneously canceling the transactions of unselected paths at the same level which won't be considered for the trading any more; and so on until it completes all the transactions.

The transactions of the system may involve trading shares of stocks in the stock market, trading of mutual funds in the stock market, trading of options in the option trading market, trading of bonds in bond trading market, trading commodities in the commodities market, trading collectibles in a collectibles trading market, trading goods in an auction trading market, trading real estate in a real estate trading market, trading of securities in security market, or any other type of market transactions where trading takes place.

The system may comprise multiple layers of trading sequences with many parallel programmable groups, each of the groups having a number of transactions, wherein the system is capable of automatically programming each of the groups independently of each of the other groups with the same automatic trading and sequencing and the system automatically enacting transactions based on the set programmed criteria within each of the groups.

The system provides a way to place multiple trading orders from one order input based on a given pattern criteria. For example buying 100 stock of Microsoft priced at $60.00 and selling the same quantity, 100 stock of Microsoft at $61.00 and the investor would like to repeat the above trading pattern 50 times. All orders in the above example can be placed by single order input.

The user should always have the flexibility of changing the order priority (which should execute first) and changing the Sequence Order partially or fully for the orders which are yet to be executed. Even if the first trade is waiting to meet certain criteria (price, etc.), the entire Sequence Trading order can be changed.

For example:

The user has the following orders as part of the Sequence Trading in the following order:

| Security | Buy/Sell | Quantity | Price | Total |
|---|---|---|---|---|
| 1: Microsoft | Buy | 100 | $60.00 (Limit order) | $6000 |
| 2: Microsoft | Sell | 100 | $62.00 (Limit order) | $6200 |
| 3: IBM | Buy | 50 | $110.00 (Limit order) | $5500 |
| 4: IBM | Sell | 50 | $120.00 (Limit order) | $6000 |
| 5: Home Depot | Buy | 100 | Market order | $5000 |
| | | | (About $50.00) | |

If the user changed his/her mind and didn't want to place the order of IBM stock (order number 3 & 4), s/he should be able to cancel orders number 3 & 4 and the new Sequence Trading order will look like the following:

| Security | Buy/Sell | Quantity | Price | Total |
|---|---|---|---|---|
| 1: Microsoft | Buy | 100 | $60.00 (Limit order) | $6000 |
| 2: Microsoft | Sell | 100 | $62.00 (Limit order) | $6200 |
| 3: Home Depot | Buy | 100 | Market order | $5000 |
| | | | (About $50.00) | |

At this point, the user decides to add a new order between numbers 2 & 3 and decides to buy and sell Intel stock. In that case the order can be changed and the new Sequence Trading order will look like the following:

| Security | Buy/Sell | Quantity | Price | Total |
|---|---|---|---|---|
| 1: Microsoft | Buy | 100 | $60.00 (Limit order) | $6000 |
| 2: Microsoft | Sell | 100 | $62.00 (Limit order) | $6200 |
| 3: Intel | Buy | 200 | $30.00 (Limit order) | $6000 |
| 4: Intel | Sell | 200 | $35.00 (Limit order) | $7000 |
| 5: Home Depot | Buy | 100 | Market order | $5000 |
| | | | (About $50.00) | |

Sequence Trading and Multiple Trading Option:

Multiple trading options will provide a user the ability to order multiple orders in such a way that only one will be executed and the remaining orders at the same order level will be cancelled. The executed order will follow the subsequent orders in sequence. For example:

Security

1: Microsoft (Buy 100 shares at Limit Price $60.00)

1.1: Microsoft (Sell 100 shares at Limit Price of $65.00)

1.2: Home Depot (Buy 100 shares at Limit Price $50.00)

1.3: Home Depot (Sell 100 shares at Limit Price $52.00)

2: Intel (Buy 200 shares at Limit Price $30.00)

2.1: Intel (Sell 200 shares at Limit Price of $33.00)

2.2: Home Depot (Buy 100 shares at Limit Price $50.00)

2.3: Home Depot (Sell 100 shares at Limit Price $52.00)

3: Home Depot (Buy 100 shares at Limit Price $50.00)

3.1: Home Depot (Sell 100 shares at Limit Price of $51.00)

3.2: Home Depot (Buy 100 shares at Limit Price $50.00)

3.3: Home Depot (Sell 100 shares at Limit Price $51.00)

3.2: Intel (Buy 200 shares at Limit Price $30.00)

3.3: Intel (Sell 200 shares at Limit Price of $31.00)

In the above example, orders 1, 2, and 3 are at the first level, out of which only one will be executed and the remaining two will be cancelled:

1: Microsoft (Buy 100 shares at Limit Price $60.00)

2: Intel (Buy 200 shares at Limit Price $30.00)

3: Home Depot (Buy 100 shares at Limit Price $50.00)

Depending on the first order executed, the next set of orders will proceed, as in the case of the first one. Once 100 Microsoft shares are bought at $60.00, the system will try to sell the same stock at the limit price of $65.00 and if that order gets executed, the system will try to buy 100 shares of Home Depot at the limit price of $50.00 and after that the system will try to sell the 100 shares of Home Depot at the price of $52.00.

1: Microsoft (Buy 100 shares at Limit Price $60.00)

1.1: Microsoft (Sell 100 shares at Limit Price of $65.00)

1.2: Home Depot (Buy 100 shares at Limit Price $50.00)

1.3: Home Depot (Sell 100 shares at Limit Price $52.00)

If the second order, Intel, gets fulfilled at the first level, orders number 1 and 3 will be cancelled and the system will try to execute the remaining orders from order number 2 as it did for order number 1 in the above example.

If the third order, Home Depot, gets fulfilled at the first level, orders number 1 and 2 will be cancelled and the system will try to execute the remaining orders from order number 3 as it did for order number 1. But in this case, there are multiple options at level 3.2, where one of the following will be executed and the other one will be cancelled:

3.2: Home Depot (Buy 100 shares at Limit Price $50.00)

3.2: Intel (Buy 200 shares at Limit Price $30.00)

Depending on the order executed, the system will try to execute the next order from that sequence. For example, in the case of: 3.2: Home Depot (Buy 100 shares at Limit Price $50.00), the system will try to sell 3.3 Home Depot (Sell 100 shares at Limit Price $51.00) and in case of 3.2: Intel (Buy 200 shares at Limit Price $30.00), the system will try to sell 3.3: Intel (Sell 200 shares at Limit Price of $31.00).

Multiple trading options allow a user to place multiple orders simultaneously and assures that only one will be executed and the remaining orders at the same order level will be cancelled. In some cases, more than one trade order may qualify for the execution at a given level. To handle this situation, a polling or similar mechanism will be put in place, so that only one trade will be executed. This mechanism will be transparent to the investor.

Multiple Buy and Sell Orders Through One Order Input and Sequence Trading:

Multiple buy and sell trade orders from one input order will provide the ability to investors to enter any number of similar trades based on a pattern through one order input which will be executed in sequence.

For example:

1—Buy 100 Microsoft stock at price $60.00

2—Sell 100 Microsoft stock at price $61.00

3—Buy 100 Microsoft stock at price $60.00

4—Sell 100 Microsoft stock at price $61.00

5—Buy 100 Microsoft stock at price $60.00

6—Sell 100 Microsoft stock at price $61.00

In above example we see the pattern of buying and selling the same stock (Microsoft) with buy price ($60.00), sell price ($61.00), and number of stocks are 100. In this particular case, we notice that same pattern is repeated for 3 times which can be any number of times e.g., 20, 1000, 5000 etc.

Based on above example at present, there is no way, one can order all 6 orders by providing one set of input and execute them in the provided sequence. Currently, one has to enter all 6 order entries, one at a time, and wait for it's trade confirmation before entering the next order even though all trades are based on a pattern.

With the help of this invention we can accomplish above with one set of input which will be valid for any number of trades:

Following is the sample input information which will be asked as part of the order:

| Order Input: | |
|---|---|
| Stock symbol: | MSFT |
| Quantity: | 100 |
| Buy Price: | $60.00 |
| Sell Price: | $61.00 |
| Start trading with: | Buy |
| Number of trades: | 6 |
| Valid till: | 60 days |

Based on the above information, system will generate the number of order entries provided by the investor as part of ‘Number of trades’ automatically so that investor doesn't need to enter the same order again and again. Please note that first entry will start with ‘Buy’ order and this order will be valid for 60 days.

In anther words, above one order input will generate following 6 order entries which will be processed in the given sequence:

1—Buy 100 Microsoft stock at price $60.00

2—Sell 100 Microsoft stock at price $61.00

3—Buy 100 Microsoft stock at price $60.00

4—Sell 100 Microsoft stock at price $61.00

5—Buy 100 Microsoft stock at price $60.00

6—Sell 100 Microsoft stock at price $61.00

Following is another example which has a slight difference in input information:

| Order Input: | |
|---|---|
| Stock symbol: | INTC |
| Quantity: | 200 |
| Buy Price: | $30.00 |
| Profit percent: | 10% |
| Start trading with: | Sell |
| Number of trades: | 100 |
| Valid till: | Jan. 1, 2003 (date) |

In this example we have ‘Profit percentage’ for selling price which will compute the selling price ($30.00+10%=$33) and order will be valid till date ‘Jan. 1, 2003’ in place of number of days. One order input will generate 100 trade orders for the investors and first order will start from ‘sell’. We assume that investor has the 200 INTC stocks at the time s/he enters this order. If customer doesn't have the stock at the time of order where first order in sequence starts with ‘sell’ in that case order type can be changed to ‘sell short’.

1—Sell 200 Intel (INTC) stock at price $33.00

2—Buy 200 Intel (INTC) stock at price $30.00

3—Sell 200 Intel (INTC) stock at price $33.00

4—Buy 200 Intel (INTC) stock at price $30.00

. . .

99—Sell 200 Intel (INTC) stock at price $33.00

100—Buy 200 Intel (INTC) stock at price $30.00

Following is one more example with slight difference in input information

| Order Input: | |
|---|---|
| Stock symbol: | MSFT |
| Quantity: | 100 |
| Buy Price: | |
| Profit percent: | 5% |
| Start trading with: | Sell |
| Number of trades: | 3 |
| Valid till: | 1 day |

This example shows that we would like to sell the MSFT stock at market price and buy price will be determined on first sell price (5% below the sell price) and order will be valid for 1 day only. Please also note that number of buy and sell orders are different (not even) in this order as number of trades are 3 (sell, buy, sell). We assume that investor has needed 100 MSFT stock to sell (first order in the sequence) at the time of order.

1—Sell 100 Microsoft stock at market price, let's say $60.00

2—Buy 100 Microsoft stock at price (5% below of sell price) $57.00

3—Sell 100 Microsoft stock at price $60.00

The above examples show that we can have multiple variations on input information but one thing will remain that system will automatically generate more than one buy or sell orders based on one set of input information and all the orders will be executed in the sequence.

During implementation of this invention, one can store all order entries in the system and execute them in the sequence. Another mechanism might be to store the input information only and internally keep track of how many orders are executed, how many more orders needs to be completed, the state of the current order (buy, sell) etc. by keeping the internal counters, that way storage space can be saved in the system.

Note:

Company names, stock symbols, and stock prices in the examples and figures are just for the explanation and they have no relation with the real market price.

In practice in FIG. 1, a diagram illustrates the sequence trading system of the present invention showing that while there are multiple orders open at the same time, they will be executed only in the order they are placed, for example, the “Sell 100 MSFT $62.00 Limit Order” 22 will not be executed until the “Buy 100 MSFT $60.00 Limit Order” 21 is executed and similarly the “Buy 100 MSFT $61.00 limit order” 23 will only be executed after the sell order 22 and the second sell order 24 will only be executed after the second buy order 23.

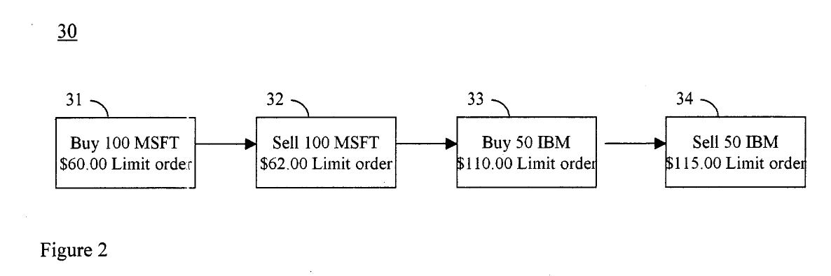

In FIG. 2, the sequence trading system of the present invention shows in the diagram that there can be multiple securities as part of the sequence order, for example buy and sell MSFT (Microsoft) 31 and 32 and buy and sell IBM 33 and 34, as compared to the single security in FIG. 1.

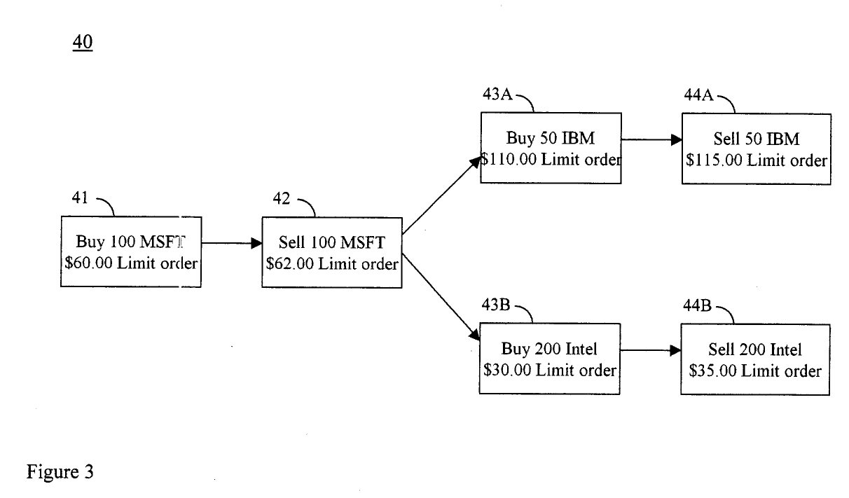

In FIG. 3, a diagrammatic view of the sequence trading system of the present invention shows that there can be multiple choices as part of the sequence trading, in which one sequence will be followed, thereby canceling the other sequence. So, after the buy MSFT 41 and sell MSFT 42 either buy and sell IBM 43A and 44A will be transacted or buy and sell Intel 43B and 44B will take place.

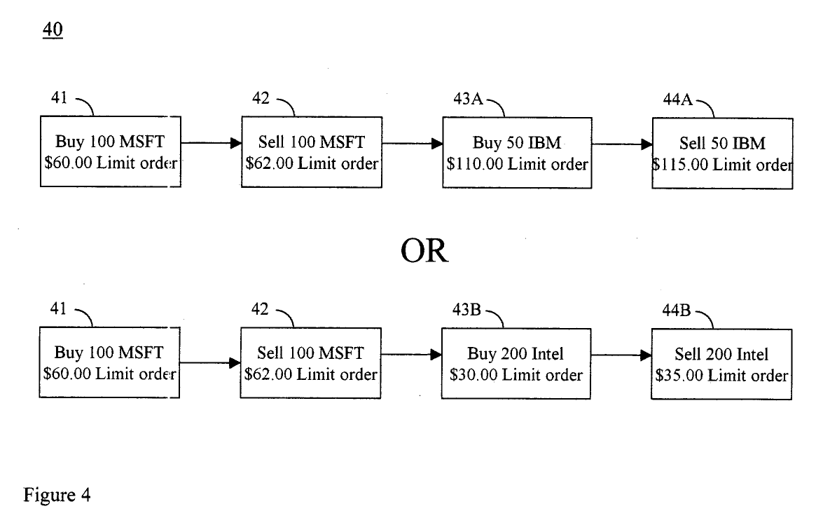

FIG. 4 shows in more detail the possible sequence paths for the scenario of FIG. 3 with two separate paths 41, 42, 43A, and 44A OR 41, 42, 43B, and 44B.

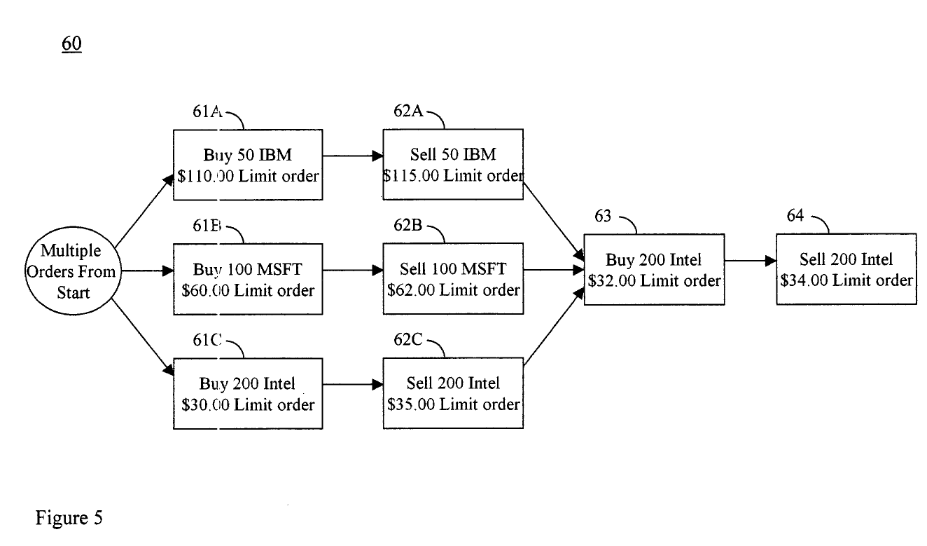

FIG. 5 is a diagrammatic view of the sequence trading system of the present invention showing that the multiple choices can occur at any point in the sequence. In this example, from the very first transaction, in contrast to the scenario in FIG. 3, where the multiple choice occurs in the middle of the sequence. So either transactions 61A and 62A take place or 61B and 62B or 61C and 62C, then followed by transactions 63 and 64.

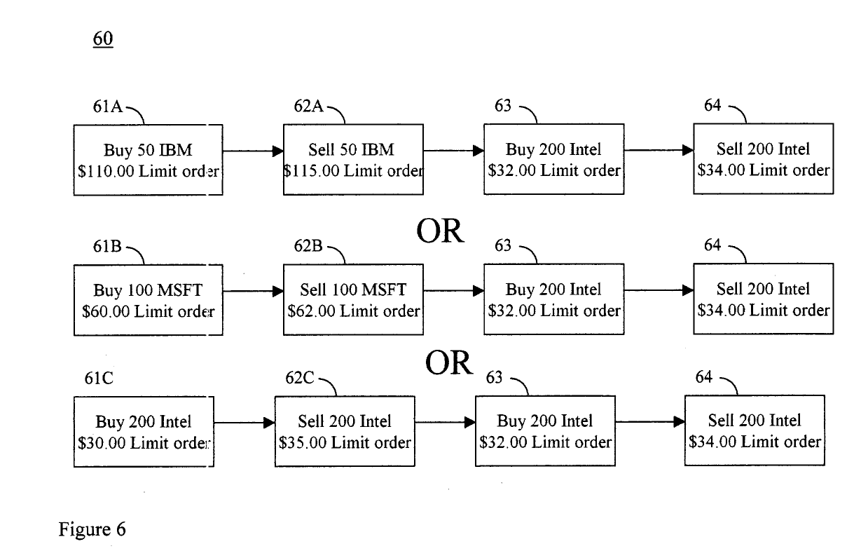

In FIG. 6, a diagrammatic view of the sequence trading system of the present invention shows more detail of the multiple choice sequence possibilities for the scenario of FIG. 5 with the three alternate paths shown separately, each beginning with a different pair of transactions 61A and 62A or 61B and 62B or 61C and 62C, but each ending in the same two transactions 63 and 64.

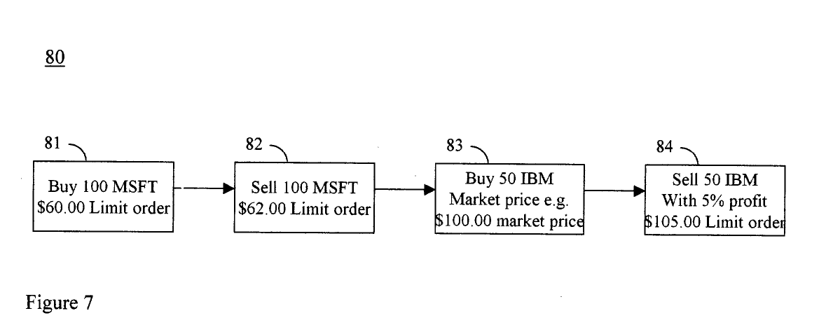

In FIG. 7, a diagrammatic view of the sequence trading system of the present invention shows that different types of orders can be placed as part of sequence trading e.g. limit buy and sell orders 81 and 82, market order 83 and a limit sell order based on price of the earlier trade 84.

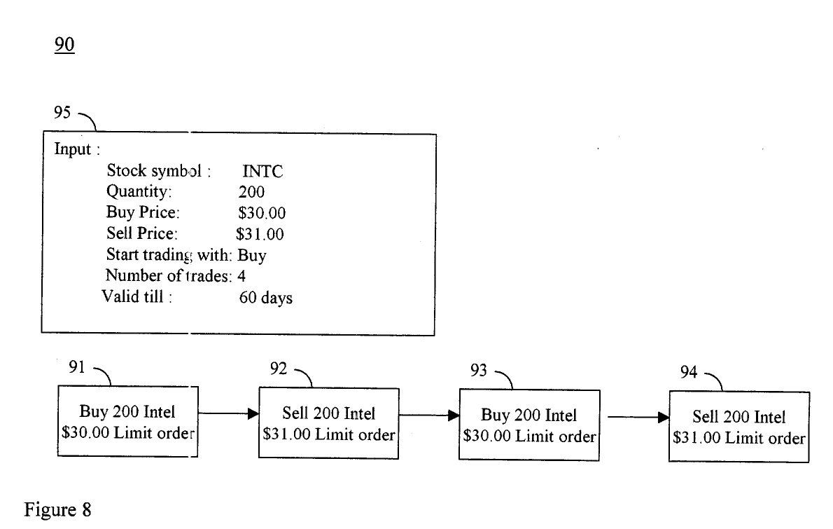

In FIG. 8, a diagrammatic view of the sequence trading system of the present invention shows that from one trading order input 95, the system can generate multiple buy and sell orders for a particular stock, in this example, Intel buy 91, Intel sell 92, Intel buy 93, and Intel sell 94.

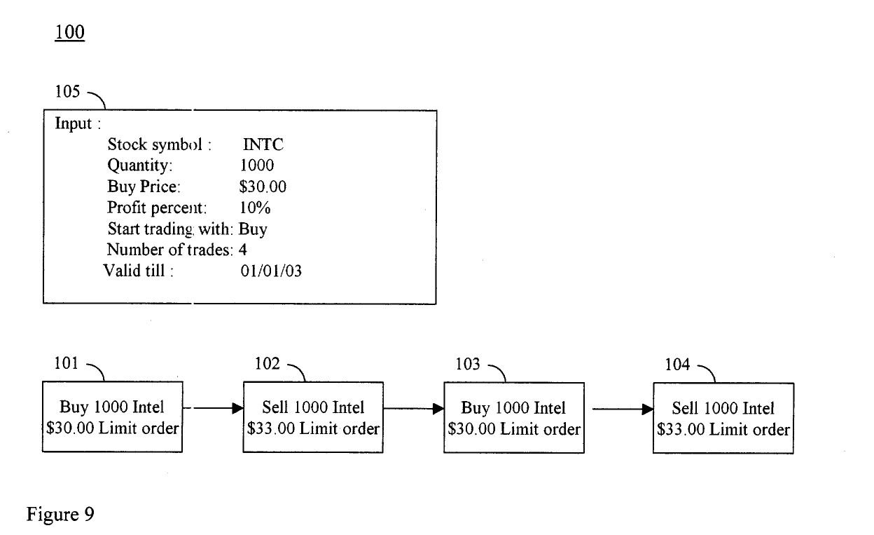

In FIG. 9, a diagrammatic view of the sequence trading system of the present invention shows the same scenario as FIG. 8, but specifying “Profit Percent” for the selling price in the trading order input 105, which computes the selling price, in this example $33.00 ($30.00+10%), and that the order will be valid until a specific date, in this example Jan. 1, 2003, instead of a number of days. Thus, the first pair of Intel buy 101 and Intel sell 102 transactions and the second pair of Intel buy 103 and Intel sell 104 transactions are based on being able to make a 10% profit in order to carry out the transactions.

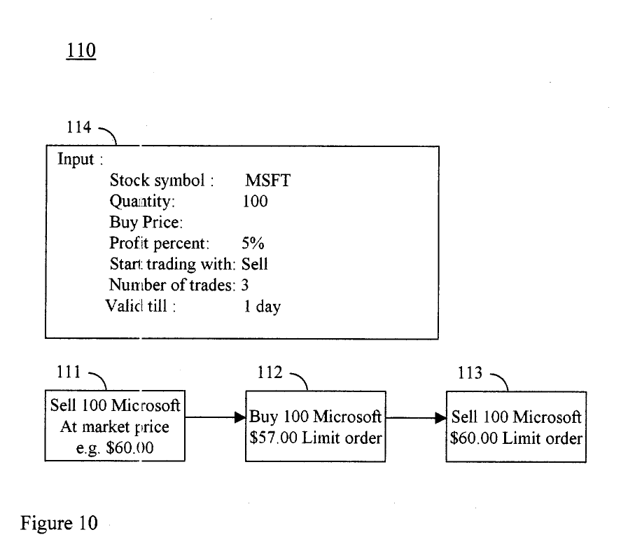

In FIG. 10, a diagrammatic view of the sequence trading system of the present invention shows an order to sell a particular stock 114, in this example, MSFT (Microsoft), at market price, and that the buy price will be determined by the first sell price, in this example, 5% below the sell price, and that the order will be valid for one day only, illustrating also that the number of buy orders can be different from the number of sell orders so that a sell order 111 is followed by a 5% lower buy order 112, and then a 5% higher sell order 113.

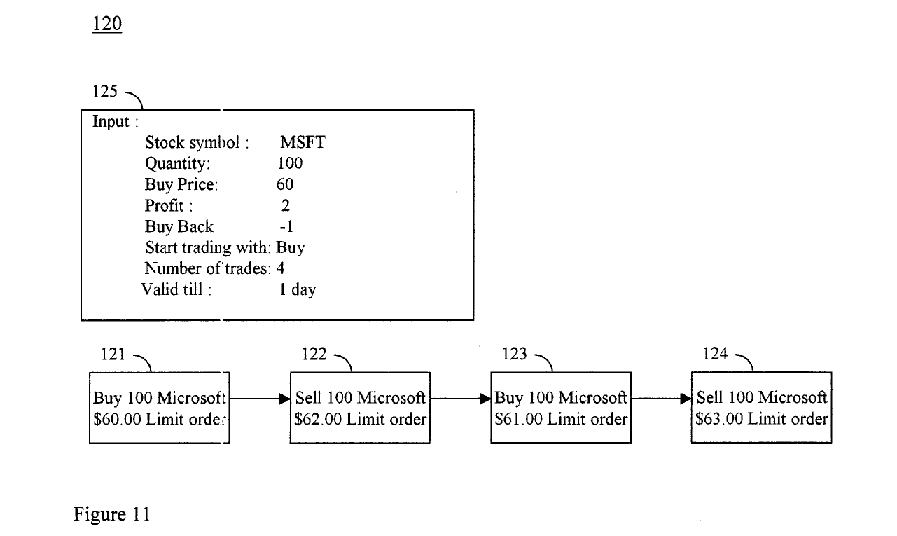

In FIG. 11, a diagrammatic view of the sequence trading system of the present invention shows a single input order to buy a particular stock 125, in this example, MSFT (Microsoft), at $60.00 121, and then sell the same stock with a $2.00 profit, in this example $62.00 ($60.00+$2.00=$62.00) 122, and then buy the same stock at $1.00 below the last sale price, in this example $61.00 ($62.00−$ 1.00=$61.00) 123 followed by selling at $63.00 124, the process continuing in sequence until all trades are completed, thereby allowing the user to make the trades even if the stock price rises and does not return to the last buy price.

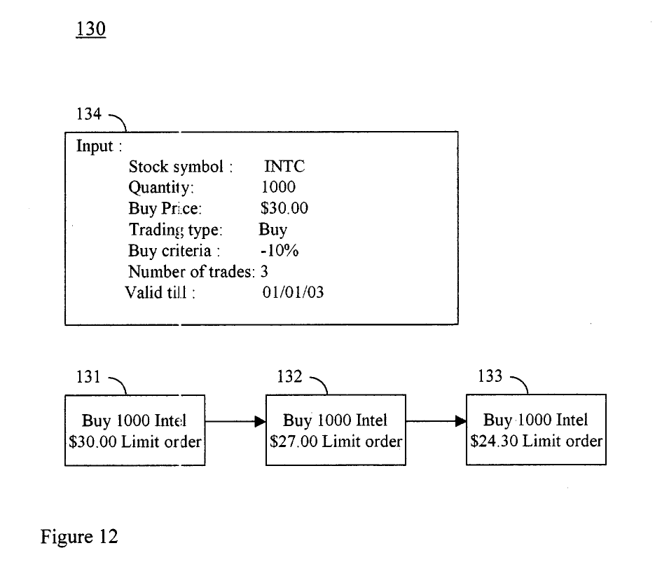

In FIG. 12 a diagrammatic view of the sequence trading system of the present invention shows the average out capability, in this example, an order to buy 1000 stock of Intel (INTC) 134 every time price of this stock goes down by 10% so that investor can average out his buying price even if the stock price continues to go down. In this example the total number of buy orders are 3 131, 132 and 133 and the first order will be executed when price of the Intel stock will be at $30.00 and the order is valid till Jan. 1, 2003. One can also choose to sell the stock in a similar fashion when the market goes up.

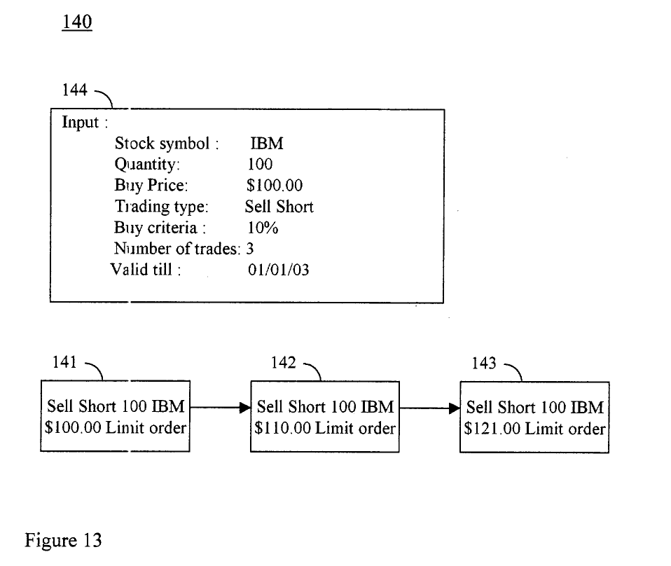

In FIG. 13, a diagrammatic view of the sequence trading system of the present invention shows the sell short order input 144. In this example, the investor would like to sell short the IBM stock every time it goes up by 10%. The first trade 141 will take place once the stock will reach a price of $100.00, the next trade 142 at the price of $110.00 ($100+10%), and the last trade 143 at the price of $121.00 ($110+10%).

It is understood that the preceding description is given merely by way of illustration and not in limitation of the invention and that various modifications may be made thereto without departing from the spirit of the invention as claimed.

What is claimed is:

1. A system for automatically programmed sequential trading for executing multiple trading orders, the system comprising:
automatically programming a number of transactions to take place in a desired sequence, the sequence being to have a first transaction of the number of transactions meeting a given order criteria take place automatically and simultaneously temporarily blocking the other transactions of the number of the transactions; and on completion of the first transaction automatically executing the next transaction based on its given order criteria and simultaneously temporarily blocking the other transactions of the number of the transactions; and
continuing the same sequence of transactions until it completes all the transactions.

2. The system of claim 1 wherein the transactions involve a type of market transaction where trading takes place.

3. The system of claim 1 wherein the transactions involve trading shares of stocks in a stock market.

4. The system of claim 1 wherein the transactions involve trading options in an option trading market.

5. The system of claim 1 wherein the transactions involve trading bonds in a bond trading market.

6. The system of claim 1 wherein the transactions involve trading securities in a security market.

7. The system of claim 1 wherein the transactions involve trading commodities in a commodities market.

8. The system of claim 1 wherein the transactions involve trading collectibles in a collectibles trading market.

9. The system of claim 1 wherein the transactions involve trading goods in an auction trading market.

10. The system of claim 1 wherein the transactions involve trading real estate in a real estate trading market.

11. The system of claim 1 wherein the system comprises a number of combinations of different sequences with the same automatic trading and sequencing wherein a transaction in any one of the different sequences is capable of taking place and simultaneously temporarily blocking all of the other transactions in all of the different sequences.

12. The system of claim 11 wherein the system comprises a number of combinations of different sequences wherein the system is capable of automatically canceling the transactions of the unselected sequence paths at the same level which won't be considered for trading any more.

13. The system of claim 1 further comprising the capability of placing multiple trading orders from a single order input which provides transaction pattern information of the trading orders.

14. The system of claim 13 wherein the system is capable of placing any number of trading orders from a single order input which provides transaction pattern information of the trading orders wherein the pattern information is defined from the group of patterns including a transaction set on buy price, sell price, profit amount, profit in percent, and change in price (up/down).

15. The system of claim 13 wherein the pattern can be defined by one or more sets of pattern information.

16. The system of claim 1 wherein the system is operable in any programmable or interactive programmable equipment including in real time and interactive real time programmable equipment.

17. The system of claim 1 wherein the system comprises the capability of executing all the transactions in a given sequence within intended investment limits based upon a real time accountability of available resources.

18. The system of claim 1 wherein the system comprises the capability of modifying and canceling any and all the transactions which are yet to be executed as needed.

19. The system of claim 1 wherein the system is programmed to carry out automatically multiple trading orders from one input which defines a desired sequence.

20. The system of claim 1 wherein the system is programmed to carry out automatically a number of trading orders which are entered explicitly and or automatically and which defines a desired sequence.
